(19) United States
(12) Patent Application Publication
(10) Pub. No.: US 2014/0168496 A1
(43) Pub. Date: Jun. 19, 2014

(54) OPTICAL COUPLING LENS DETECTION SYSTEM AND METHOD

(71) Applicant: HON HAI PRECISION INDUSTRY CO., LTD., New Taipei (TW)

(72) Inventor: YI HUNG, Tu-Cheng (TW)

(73) Assignee: HON HAI PRECISION INDUSTRY CO., LTD., New Taipei (TW)

(21) Appl. No.: 14/040,478

(22) Filed: Sep. 27, 2013

(30) Foreign Application Priority Data
Dec. 14, 2012 (TW) 101147654

(51) Int. Cl. G02B 17/08

(52) U.S. Cl. CPC G02B 17/0876
USPC 348/335; 359/726

(57) ABSTRACT

An optical coupling lens detection system includes an optical coupling lens and a planar mirror. The optical coupling lens includes a light incident surface, a light output surface perpendicular to the light incident surface, a reflection surface obliquely interconnected between the light incident surface and the light output surface, first converging portions, second converging portions corresponding to the first converging portions, a first locating post, a second locating post, two first engaging posts, and two second engaging posts corresponding to the two first engaging posts. One end of the planar mirror contacts an intersecting line between the reflection surface and the light output surface, and an opposite end of the planar mirror is far away the light output surface, an included angle between the planar mirror and the light output surface is about 45 degrees, and a mirror surface of the planar mirror faces toward the light output surface.

### BACKGROUND

1. Technical Field

The present disclosure relates to communication technologies and, particularly, to an optical coupling lens detection system and an optical coupling lens detection method.

2. Description of Related Art

An optical coupling lens is preferred for use in data transmission between electronic devices. The optical coupling lens is formed by an injection molding die. The optical coupling lens includes a light incident surface, a light output surface perpendicularly connected to the light incident surface, a reflection surface obliquely interconnected between the light incident surface and the light output surface, at least one first converging portion, and at least one second converging portion corresponding to the at least one first converging portion. The shape and the dimensions of each first converging portion are the same as those of the corresponding second converging portion. The reflection surface is configured for reflecting light converged by each first converging portion toward the corresponding second converging portion, and for reflecting light converged by each second converging portion toward the corresponding first converging portion.

When a first optical axis of each first converging portion intersects with a second optical axis of the corresponding second converging portion at a point on the reflection surface, all light converged by the first converging portion enters the second converging portion, and all light converged by the second converging portion enters the first converging portion. In this situation, the optical coupling efficiency of the optical coupling lens is at maximum, and the quality of the optical coupling lens is at maximum. The quality of the optical coupling lens needs to be determined after the optical coupling lens is molded. Therefore, it is important to have an optical coupling lens detection system and an optical coupling lens detection method which can determine whether the first optical axis intersects with the second optical axis at a point on the reflection surface or not.

### BRIEF DESCRIPTION OF THE DRAWINGS

FIG. 1 is a schematic, isometric view of an optical coupling lens detection system according to a first exemplary embodiment, the optical coupling lens detection system including an image capturing device, a planar mirror and an optical coupling lens.

FIG. 2 is a schematic, isometric view of the optical coupling lens and the planar mirror of FIG. 1.

FIG. 3 is a schematic view of a first image captured by the image capturing device of the optical coupling lens detection system of FIG. 1.

FIG. 4 is a cross-sectional view of the optical coupling lens of FIG. 1, taken along line IV-IV thereof, and showing essential optical paths thereof

FIG. 5 is a schematic view of a second image captured by the image capturing device of the optical coupling lens detection system of FIG. 1.

FIG. 6 is a schematic, isometric view of an optical coupling lens detection system according to a second exemplary embodiment.

### DETAILED DESCRIPTION

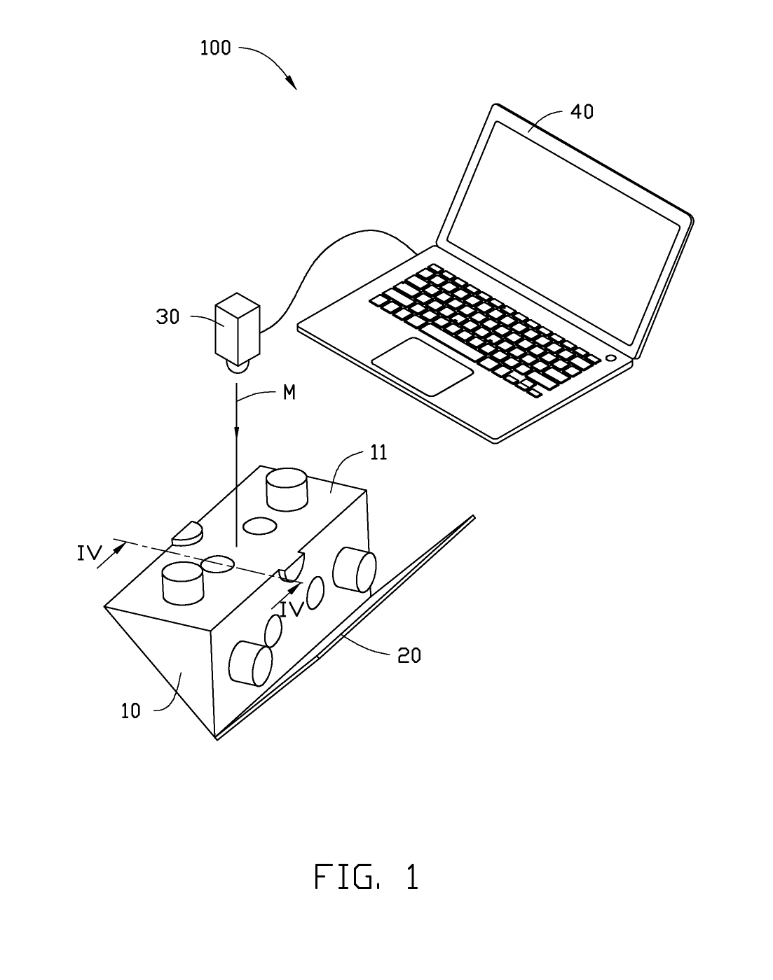

FIG. 1 shows an optical coupling lens detection system 100 according to a first exemplary embodiment. The optical coupling lens detection system 100 includes an optical coupling lens 10, a planar mirror 20, an image capturing device 30, and an analysis device 40.

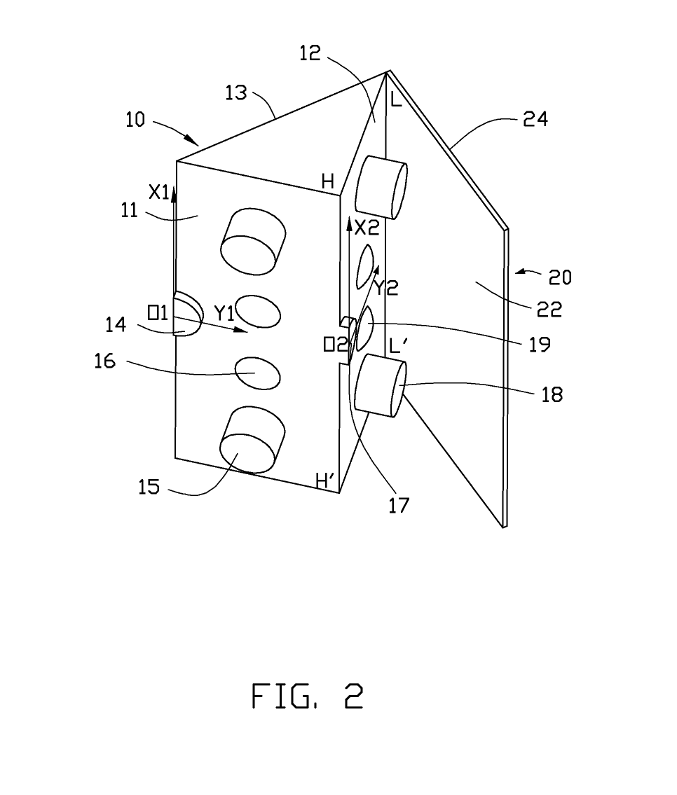

Referring also to FIG. 2, the optical coupling lens 10 is substantially a straight triangular prism. The optical coupling lens 10 includes a light incident surface 11, a light output surface 12, a reflection surface 13, a first locating post 14, two first engaging posts 15, two first converging portions 16, a second locating post 17, two second engaging posts 18, and two second converging portions 19.

The light incident surface 11 intersects with the light output surface 12 to form a first intersecting line HH′, with the light incident surface 11 being perpendicular to the light output surface 12. The reflection surface 13 is obliquely interconnected between the light incident surface 11 and the light output surface 12, and the reflection surface 13 intersects with the light output surface 12 to form a second intersecting line LL′. An included angle between the light incident surface 11 and the reflection surface 13 is about 45 degrees, and an included angle between the light output surface 12 and the reflection surface 13 is about 45 degrees.

The first locating post 14, the two first engaging posts 15, and the two first converging portions 16 are arranged on the light incident surface 11, and are spaced apart from each other. The first locating post 14 is substantially a semi-cylinder, and is substantially perpendicular to the light incident surface 11. Each of the first engaging posts 15 is substantially a cylinder, and is substantially perpendicular to the light incident surface 11. The two first engaging posts 15 and the two first converging portions 16 are arranged in a straight line, and the two first converging portions 16 are located between the two first engaging posts 15. That is, the centers of the two first engaging posts 15 and the centers of the two first converging portions 16 are arranged in a straight line. Each of the first converging portions 16 is a convex lens.

The second locating post 17, the two second engaging posts 18, and the two second converging lenses 19 are arranged on the light output surface 12, and are spaced apart from each other. The second locating post 17 is substantially a semi-cylinder, and is substantially perpendicular to the light output surface 12. A central axis of the second locating post 17 intersects with a central axis of the first locating post 14 at a point on the reflection surface 13. In this embodiment, the first locating post 14 is positioned at an edge of the light incident surface 11, and the second locating post 17 is positioned at an edge of the light output surface 13. The point at which the central axis of the second locating post 17 intersects with the central axis of the first locating post 14 is located on an intersecting line between the light incident surface 11 and the reflection surface 13. The two second engaging posts 18 correspond to the two first engagement posts 15 one-to-one. Each of the second engaging posts 18 is substantially a cylinder, and each of the second engaging posts 18 is substantially perpendicular to the light output surface 12. The two second engaging posts 18 and the two second converging portions 19 are arranged in a straight line, and the second converging portions 19 are located between the two second engaging posts 19. That is, centers of the two second engaging posts 18 and centers of the two second converging portions 19 are arranged in a straight line. Each of the second converging portions 19 is a convex lens. The second converging portions 19 correspond to the first converging portions 16 one-to-one.

The location relationship between each of the first converging portions 16 and each of the first engaging posts 15 is substantially the same as that between each of the second converging portions 19 and each of the second engaging posts 18. In detail, assume that a first Cartesian coordinate system is provided in the light incident surface 11, and a second Cartesian coordinate system is provided in the light output surface 12. The center of the first locating post 14 serves as an origin O1 of the first Cartesian coordinate system. An X1 coordinate axis of the first Cartesian coordinate system passes through the origin O1 and is parallel to the first intersecting line HH′. A Y1 coordinate axis of the first Cartesian coordinate system passes through the origin O1 and is perpendicular to the X1 coordinate axis. The center of the second locating post 17 serves as an origin O2 of the second Cartesian coordinate system. An X2 coordinate axis of the second Cartesian coordinate system passes through the origin O2 and is parallel to the first intersecting line HH′. A Y2 coordinate axis of the second Cartesian coordinate system passes through the origin O2 and is perpendicular to the X2 coordinate axis. The difference between the coordinate value of each of the first converging portions 16 and the coordinate value of each of the first engaging posts 15 is substantially the same as the difference between the coordinate value of each of the corresponding second converging portions 19 and the coordinate value of each of the corresponding second engaging posts 18. The diameter of each of the first engaging posts 15 far exceeds the diameter of each of the first converging portions 16. For example, the diameter of each of the first engaging posts 15 is ten times larger than the diameter of each of the first converging portions 16. Similarly, the diameter of each of the second engaging posts 18 far exceeds the diameter of each of the second converging portions 19. For example, the diameter of each of the second engaging posts 18 is ten times larger than the diameter of each of the second converging portions 19.

The planar mirror 20 includes a mirror surface 22 and a back surface 24. The mirror surface 22 and the back surface 24 are positioned at opposite sides of the planar mirror 20, and the mirror surface 22 is substantially parallel to the back surface 24. One long side edge of the planar mirror 20 contacts the second intersecting line LL′, and an opposite long side edge of the planar mirror 20 is away from the optical coupling lens 10. An included angle between the planar mirror 20 and the light output surface 12 is about 45 degrees, and the mirror surface 22 faces the light output surface 12. The planar mirror 20 is configured for making a mirror image of the entire light output surface 12 and objects (including the second locating post 17, the two second engaging posts 18, and the two second converging portions 19) located on the light output surface 12.

FIG. 1 shows that the image capturing device 30 is typically a digital camera. The image capturing device 30 is positioned outside the optical coupling lens 10, and faces the light incident surface 11. In detail, the optical axis M of the image capturing device 30 is substantially perpendicular to the light incident surface 11. The image capturing device 30 is configured for capturing a digital image showing the entire light incident surface 11 and the entire mirror surface 22.

FIG. 1 shows that the analysis device 40 is positioned outside the optical coupling lens 10, and is electrically connected to the image capturing device 30. In the illustrated embodiment, the analysis device 40 is comprised in a notebook computer. The analysis device 40 is configured for analyzing whether an offset is formed between a first center M₁ of each of image portions 15a of the first engaging posts 15 in the digital image (hereinafter “first engaging post image portion 15a”) and a second center M₂ of an image portion 18b of a mirror image of the corresponding second engaging post 18 in the digital image (hereinafter “second engaging post mirror image portion 18b”) according to a symmetry principle. In addition, the analysis device 40 is configured for calculating the offset value if there is an offset. If there is an offset, the offset value is represented by the fact that a first optical axis of each of the first converging portions 16 cannot intersect with a second optical axis of each of the second converging portions 19 at a point on the reflection surface 13. In addition, the offset value between the first center M₁ and the second center M₂ is equal to the offset value between the first optical axis and the second optical axis on the reflection surface 13. During the analysis process, an image portion 14a of the first locating post 14 in the digital image (hereinafter “the first locating post image portion 14a”) and an image portion 17b of a mirror image of the second locating post 17 in the digital image (hereinafter “the second locating post mirror image portion 17b”) serve as reference points.

FIGS. 1-3 show an optical coupling lens detection method using the optical coupling lens system 100, according to an exemplary embodiment. The method includes the following steps.

First, the image capturing device 30 is placed to face the light incident surface 11. In detail, the optical axis M of the image capturing device 30 is substantially perpendicular to the light incident surface 11.

Second, the image capturing device 30 captures a digital image showing the entire light incident surface 11 and the entire mirror surface 22.

Third, the first locating post image portion 14a and the second locating post mirror image portion 17b are used as reference points. Whether an offset is formed between the first center M₁ of each of the first engaging post image portions 15a and a second center M₂ of each of the second engaging post mirror image portions 18b is analyzed by the analysis device 40 according to the symmetry principle.

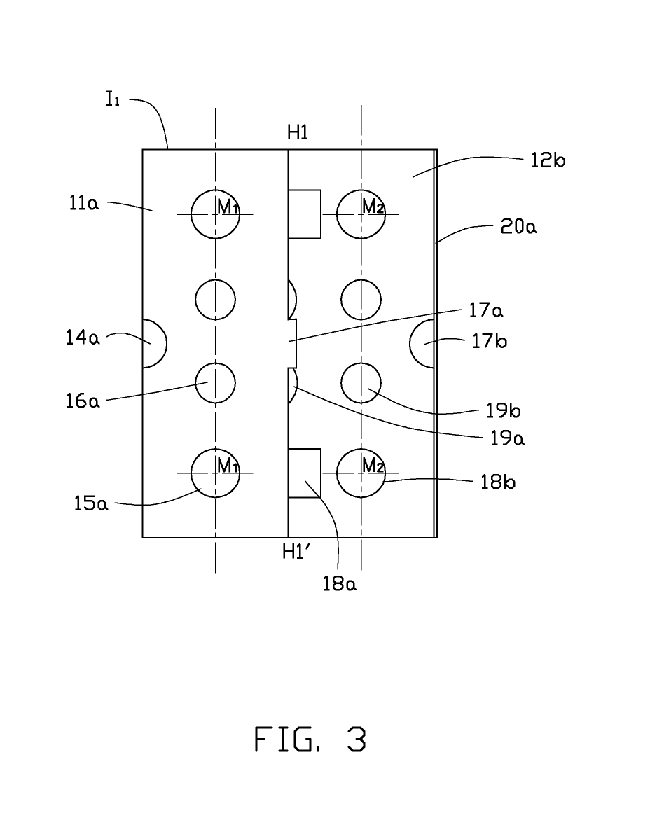

In the case that the image capturing device 30 captures a first digital image I₁, as shown in FIG. 3, the above-described analysis steps include the following details. The first digital image I₁ shows an image portion 11a of the light incident surface 11 (hereinafter “the light incident surface image portion 11a”), an image portion H1H1′ of the first intersecting line HH′ (hereinafter “the first intersecting line image portion H1H1′”), the first locating post image portion 14a, the two first engaging post image portions 15a, two image portions 16a of the first converging portions 16 (hereinafter “the first converging portion image portions 16a”), an image portion 17a of the second locating post 17 (hereinafter “the second locating post image portion 17a”), two image portions 18a of the two second engaging posts 18 (hereinafter “the second engaging post image portions 18a”), two image portions 19a of the two second converging portions 19 (hereinafter “the second converging portion image portions 19a”), an image portion 20a of the planar mirror 20 (hereinafter “the planar mirror image portion 20a”), an image portion 12b of a mirror image of the light output surface 12 (hereinafter “the light output surface mirror image portion 12b”), the second locating post mirror image portion 17b, two image portions 18b of mirror images of the two second engaging posts 18 (hereinafter “the second engaging post mirror image portions 18b”), and two image portions 19b of mirror images of the two second converging portions 19 (hereinafter “the second converging portion mirror image portions 19b”).

The analysis device 40 analyzes that the connection line M₁M₁ is symmetric to the connection line M₂M₂ about the first intersecting line image portion H1H1′ according to the symmetry principle. Therefore the first optical axis of each of the first converging portions 16 intersects with the second optical axis of the corresponding second converging portion 19 at a point on the reflection surface 13, because the location relationship between each of the first converging portions 16 and each of the first engaging posts 15 is substantially the same as that between each of the second converging portions 19 and each of the second engaging posts 18. In other words, there is no offset between the first optical axis of each of the first converging portions 16 and the second optical axis of the corresponding second converging portion 19.

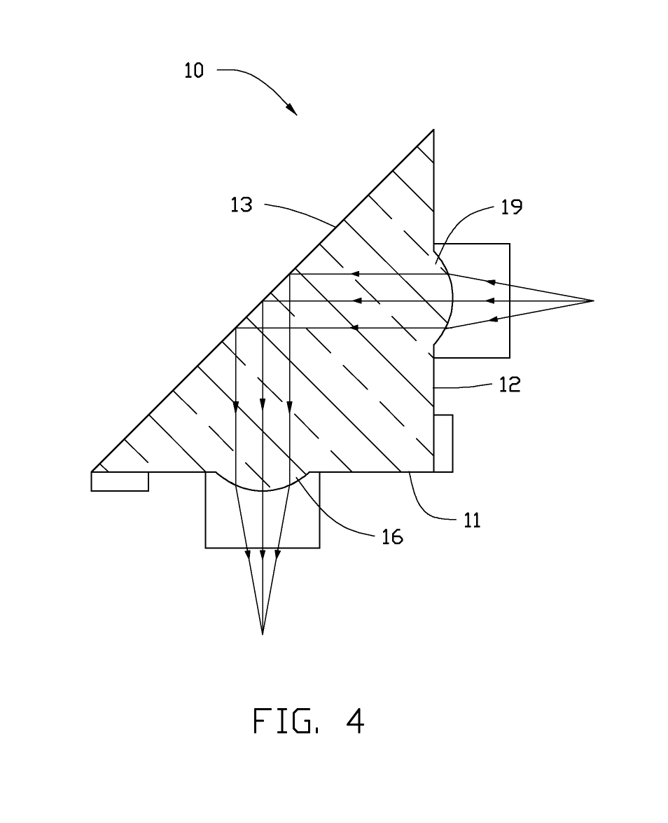

FIG. 4 shows that if there is no offset between the first optical axis of each of the first converging portions 16 and the second optical axis of the corresponding second converging portion 19, the optical coupling lens 10 works as follows. Light beams emitted from a light emitting module (not shown) enter the first converging portion 16 and become parallel light beams. The parallel light beams are reflected about 90 degrees toward the corresponding second converging portion 19 by the reflection surface 13, and are finally converged to an optical fiber (not shown) by the corresponding second converging portion 19. Correspondingly, light beams from the optical fiber enter the second converging portion 19 and become parallel light beams. The parallel light beams are reflected about 90 degrees toward the corresponding first converging portion 16 by the reflection surface 13, and are finally converged to a light receiving module (not shown) by the corresponding first converging portion 16.

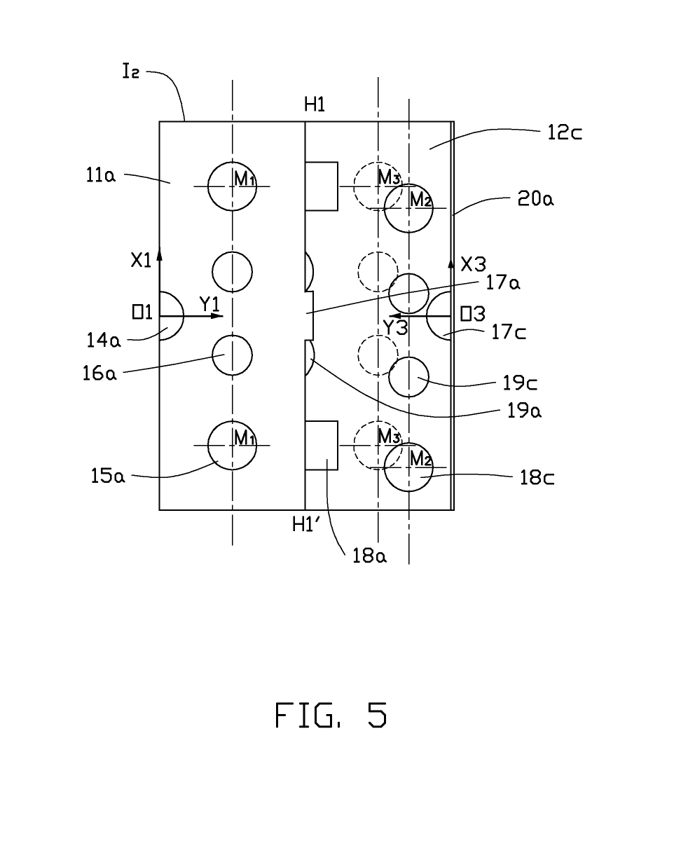

In the case that the image capturing device 30 captures a second digital image I₂, as shown in FIG. 5, the above-described analysis steps include the following details. The second digital image I₂ shows the light incident surface image portion 11a, the first intersecting line image portion H1H1′, the first locating post image portion 14a, the two first engaging post image portions 15a, the two first converging portion image portions 16a, the second locating post image portion 17a, the two second engaging post image portions 18a, the two second converging portion image portions 19a, the planar mirror image portion 20a, the light output surface mirror image portion 12c, the second locating post mirror image portion 17c, two second engaging post mirror image portions 18c, and two second converging portion mirror image portions 19c.

The analysis device 40 analyzes that the connection line M₁M₁ is not symmetric to the connection line M₂M₂ about the first intersecting line image portion H1H1′ according to the symmetry principle. Therefore the first optical axis of each of the first converging portions 16 cannot intersect with the second optical axis of the corresponding second converging portion 19 at a point on the reflection surface 13. In other words, there is an offset between the first optical axis of each of the first converging portions 16 and the second optical axis of the corresponding second converging portion 19.

In this situation, the analysis device 40 further calculates the offset value between the first optical axis of each of the first converging portions 16 and the second optical axis of the corresponding second converging portion 19. In detail, a third Cartesian coordinate system is provided in the light output surface mirror image portion 12c. The center of the second locating post mirror image portion 17c serves as an origin O3 of the third Cartesian coordinate system. An X3 coordinate axis of the third Cartesian coordinate system passes through the origin O3 and is parallel to the first intersecting line image portion H1H1′. A Y3 coordinate axis of the third Cartesian coordinate system passes through the origin O3 and is perpendicular to the X3 coordinate axis. Two symmetry points M₃ of the two centers M₁ of the two first engaging post image portions 15a relative to the first intersecting line image portion H1H1′ are simulated. The offset value between the first optical axis of each of the first converging portions 16 and the second optical axis of the corresponding second converging portion 19 satisfies the following formula: ΔX=X2−X1, and ΔY=Y2−Y1, wherein (X1, Y1) is the coordinate value of each of the symmetry points M₃, and (X2, Y2) is the coordinate value of each of centers M2 of the two second engaging post mirror image portions 18c. The offset value can be applied to amend or adjust an injection molding die which is used to form the optical coupling lens 10.

In other embodiments, the number of first converging lenses 16 may be arbitrarily set according to need, and the number of second converging lenses 19 may be arbitrarily set according to need, as long as the number of first converging lenses 16 is equal to the number of second converging lenses 19. The cross-section of the first locating post 14 may be substantially triangular, rectangular, or elliptic; and the cross-section of the second locating post 17 may be substantially triangular, rectangular, or elliptic, as long as the central axis of the first locating post 14 intersects with the central axis of the second locating post 17 at a point on the reflection surface 13. Similarly, the cross-section of each of the first engaging posts 15 may be substantially triangular, rectangular, or elliptic; and the cross-section of each of the second engaging posts 18 may be substantially triangular, rectangular, or elliptic.

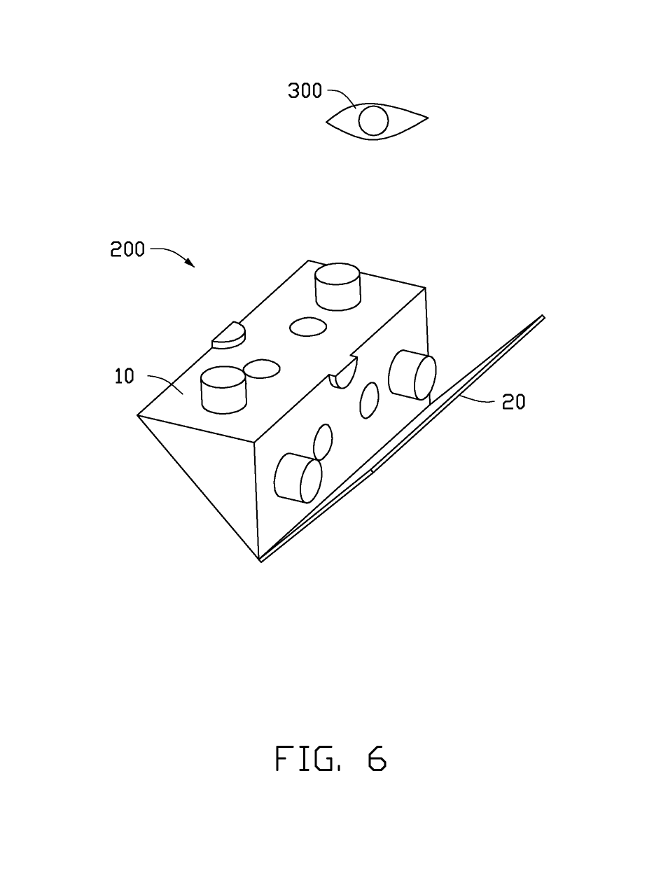

FIG. 6 shows an optical coupling lens detection system 200 according to a second exemplary embodiment. The differences between the optical coupling lens detection system 200 of the second embodiment and the optical coupling lens detection system 100 of the first embodiment are as follows. In the optical coupling lens detection system 200, the image capturing device 30 and the analysis device 40 are omitted. Instead, when the optical coupling lens detection system 200 detects the optical coupling lens 10, a human operator observes the optical coupling lens 10 and the mirror image of the light output surface 12 with the naked eye(s) 300, and such person executes the analysis step. In detail, the operator can observe the connection line M₁M₁ and the connection line M₂M₂ and determine whether the connection line M₁M₁ is symmetric to the connection line M₂M₂ about the first intersecting line HH′. The optical coupling lens detection system 200 cannot calculate the offset value between the first optical axis of each of the first converging portions 16 and the second optical axis of the corresponding second converging portion 19 if there is an offset.

Even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An optical coupling lens detection system comprising:
an optical coupling lens comprising a light incident surface, a light output surface perpendicular to the light incident surface, a reflection surface obliquely interconnected between the light incident surface and the light output surface, at least one first converging portion, at least one second converging portion corresponding to the at least one first converging portion, a first locating post, a second locating post, two first engaging posts, and two second engaging posts corresponding to the two first engaging posts;
an included angle between the light incident surface and the reflection surface being about 45 degrees;
the first locating post, the at least one first converging portion, and the two first engaging posts arranged on the light incident surface, and the second locating post, the at least one second converging portion, and the two second engaging posts arranged on the light output surface;
a central axis of the first locating post intersecting with a center axis of the second locating post at a point on the reflection surface; and
the location relationship between each of the at least one first converging portion and each of the first engaging posts being substantially the same as that between each of the corresponding at least one second converging portion and each of the second engaging posts; and
a planar mirror, one end of the planar mirror contacting an intersecting line between the reflection surface and the light output surface, and an opposite end of the planar mirror being far away the light output surface, an included angle between the planar mirror and the light output surface being about 45 degrees, and a mirror surface of the planar mirror facing toward the light output surface.

2. The optical coupling lens detection system of claim 1, further comprising an image capturing device, wherein the image capturing device is positioned outside the optical coupling lens, an optical axis of the image capturing device is substantially perpendicular to the light incident surface, and the image capturing device is configured for capturing a digital image showing the entire light incident surface and the entire mirror surface.

3. The optical coupling lens detection system of claim 2, further comprising an analysis device positioned outside the optical coupling lens and electrically connected to the image capturing device, wherein the analysis device is configured for analyzing whether an offset is formed between a first center of each of image portions of the first engaging posts in the digital image and a second center of an image portion of a mirror image of the corresponding second engaging post in the digital image according to a symmetry principle, and is also configured for calculating the offset value if there is an offset.

4. The optical coupling lens detection system of claim 1, wherein the at least one first converging portion is located between the two first engaging posts, the at least one first converging portion and the two first engaging posts are arranged in a straight line, the at least one second converging portion is located between the two second engaging posts, and the at least one second converging portion and the two second engaging posts are arranged in a straight line.

5. The optical coupling lens detection system of claim 1, wherein each of the first engaging posts and each of the second engaging posts is substantially a cylinder, and each of the first locating posts and each of the second locating posts is substantially a semi-cylinder.

6. An optical coupling lens detection method comprising:
providing an optical coupling lens and a planar mirror;
the optical coupling lens comprising a light incident surface, a light output surface perpendicular to the light incident surface, a reflection surface obliquely interconnected between the light incident surface and the light output surface, at least one first converging portion, at least one second converging portion corresponding to the at least one first converging portion, a first locating post, a second locating post, two first engaging posts, and two second engaging posts corresponding to the two first engaging posts;
an included angle between the light incident surface and the reflection surface being about 45 degrees;
the first locating post, the at least one first converging portion, and the two first engaging posts arranged on the light incident surface, and the second locating post, the at least one second converging portion, and the two second engaging posts arranged on the light output surface;
a central axis of the first locating post intersecting with a center axis of the second locating post at a point on the reflection surface; and
the location relationship between each of the at least one first converging portion and each of the first engaging posts being substantially the same as that between each of the corresponding at least one second converging portion and each of the corresponding second engaging posts;
one end of the planar mirror contacting an intersecting line between the reflection surface and the light output surface, and an opposite end of the planar mirror being far away the light output surface, an included angle between the planar mirror and the light output surface being about 45 degrees, and a mirror surface of the planar mirror facing toward the light output surface;
capturing a digital image showing the entire light incident surface and the entire mirror surface; and
observing the light incident surface and the mirror surface and analyzing whether an offset is formed between a first center of each of image portions of the first engaging posts in the digital image and a second center of an image portion of a mirror image of the corresponding second engaging post in the digital image according to a symmetry principle.

7. The optical coupling lens detection method of claim 6, wherein the observing and the analyzing step comprises:
providing an image capturing device and an analysis device;
placing the image capturing device to face the light incident surface;
capturing the digital image showing the entire light incident surface and the entire mirror surface using the image capturing device; and
analyzing whether an offset is formed between a first center of each of image portions of the first engaging posts in the digital image and a second center of an image portion of a mirror image of the corresponding second engaging post in the digital image according to a symmetry principle using the analysis device.

8. The optical coupling lens detection method of claim 7, wherein if an offset is formed between the first center and the second center, the method further comprises calculating the offset value.

9. The optical coupling lens detection method of claim 6, wherein the at least one first converging portion is located between the two first engaging posts, the at least one first converging portion and the two first engaging posts are arranged in a straight line, the at least one second converging portion is located between the two second engaging posts, and the at least one second converging portion and the two second engaging posts are arranged in a straight line.

10. The optical coupling lens detection method of claim 6, wherein each of the first engaging posts and the second engaging posts is substantially a cylinder, and each of the first locating post and the second locating post is substantially a semi-cylinder.
